(19) United States
(12) Patent Application Publication
(10) Pub. No.: US 2019/0130656 A1
(43) Pub. Date: May 2, 2019

(54) SYSTEMS AND METHODS FOR ADDING NOTATIONS TO VIRTUAL OBJECTS IN A VIRTUAL ENVIRONMENT

(71) Applicant: Tsunami VR, Inc., Del Mar, CA (US)

(72) Inventors: Morgan Nicholas GEBBIE, Carlsbad, CA (US); Anthony DUCA, Carlsbad, CA (US)

(21) Appl. No.: 16/177,131

(22) Filed: Oct. 31, 2018

Related U.S. Application Data
(60) Provisional application No. 62/580,141, filed on Nov. 1, 2017.

(51) Int. Cl. G06T 19/20; G06T 19/00

(52) U.S. Cl. CPC G06T 19/20; G06T 2219/2008; G06T 2219/004; G06T 19/003

(57) ABSTRACT

Systems, methods, and computer readable media for adding annotations to a virtual object in a virtual environment are provided. The method can include determining, at a server, that a virtual tool within the virtual environment operated via a first user device intersects the virtual object at a first location. The method can include receiving, at the server, an indication of a selection of an annotation option at the first user device to generate the annotation on the virtual object. If the indication is associated with creating a drawing, the method can include saving the first location to the memory, detecting movement of the tool within the virtual environment, saving the drawing based on the movement of the tool to a memory, and displaying, via the first user device, the drawing at the first location.

### CROSS REFERENCE TO RELATED APPLICATIONS

This application claims priority to U.S. Provisional Patent Application Ser. No. 62/580,141, filed Nov. 1, 2017, entitled “SYSTEMS AND METHODS FOR ADDING NOTATIONS TO VIRTUAL OBJECTS IN A VIRTUAL ENVIRONMENT,” the contents of which are hereby incorporated by reference in their entirety.

### BACKGROUND

### Technical Field

This disclosure relates to virtual reality (VR), augmented reality (AR), and hybrid reality technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, VR, and AR via immersive technology.

### SUMMARY

An aspect of the disclosure provides a method for adding annotations to a virtual object in a virtual environment. The method can include determining, at a server, that a virtual tool within the virtual environment operated via a first user device intersects the virtual object at a first location. The method can include receiving, at the server, an indication of a selection of an annotation option at the first user device to generate the annotation on the virtual object. If the indication is associated with creating a drawing, the method can include saving the first location to the memory, detecting movement of the tool within the virtual environment, saving the drawing based on the movement of the tool to a memory, and displaying, via the first user device, the drawing at the first location.

Another aspect of the disclosure provides a non-transitory computer-readable medium comprising instructions for adding annotations to a virtual object in a virtual environment. When executed by one or more processors, the instruction cause the one or more processors to determine that a virtual tool within the virtual environment operated via a first user device intersects the virtual object at a first location. The instructions further cause the one or more processors to receive an indication of a selection of an annotation option at the first user device to generate the annotation on the virtual object. If the indication is associated with creating a drawing, the instructions further cause the one or more processors to save the first location to the memory, detect movement of the tool within the virtual environment, save the drawing based on the movement of the tool to a memory, and display, via the first user device, the drawing at the first location.

Another aspect of the disclosure provides a method for adding annotations to a virtual object in a virtual environment. The method can include determining, at a server, that a virtual tool within the virtual environment operated via a first user device intersects the virtual object at a first location. The method can include receiving, at the server, an indication of a selection of an annotation option at the first user device to generate an attachment to the virtual object. The method can include determining a type of attachment to attach to the virtual object. The method can include saving the attachment with an association to the first location to the memory displaying, via the first user device, an indication of the attachment at the location saved to memory.

Other features and benefits will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of an embodiment of a system for or rendering a virtual object based on one or more conditions;

FIG. 1B is a functional block diagram of another embodiment of a system for rendering a virtual object based on one or more conditions;

FIG. 2 depicts a process for notating on virtual objects;

FIG. 3 depicts a process for determining a user-created notation for a virtual object;

FIG. 4A through FIG. 4D each depict a different process for detecting an annotation initiation action by a user;

FIG. 5 depicts a process for determining if the user is allowed to create an annotation;

FIG. 6 depicts a process for determining a type of notation;

FIG. 7A through FIG. 7B depict processes for recording and saving an annotation;

FIG. 8A through FIG. 8C depict processes for providing an annotation to a user device, presenting the annotation to a user, and exporting notations;

FIG. 9A through FIG. 9I depict a method with sub-processes for detecting and capturing a journal entry in a virtual environment;

FIG. 10A through FIG. 10C depict different method for detecting, capturing and displaying an annotation; and

FIG. 11A through FIG. 11C depict screen shots showing different notations.

### DETAILED DESCRIPTION

In a collaborative environment like a design environment, it is beneficial to have access to images of the object that is being designed. Notes and drawings showing revisions to the object can be added to the images in a manner that often covers the object. New images need to be created to remove the notes. Alternatively, notes like text, audio and video can be provided in separate files that may separate from the images during collaboration, that may not be readily available to participants during the collaborative process, or that may not be easily used by those participants.

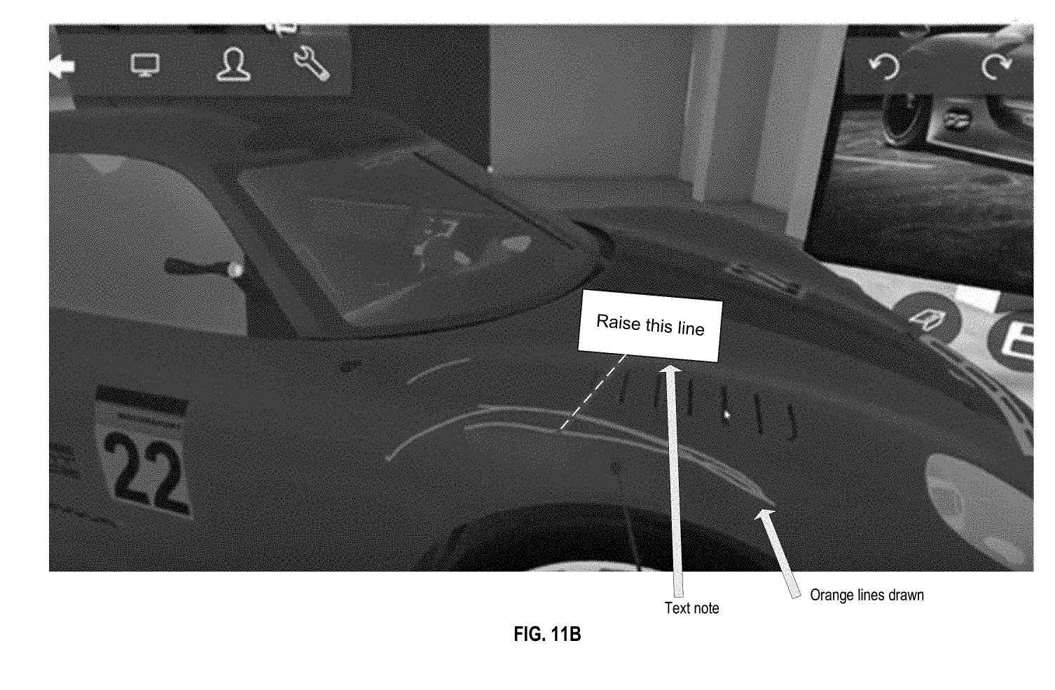

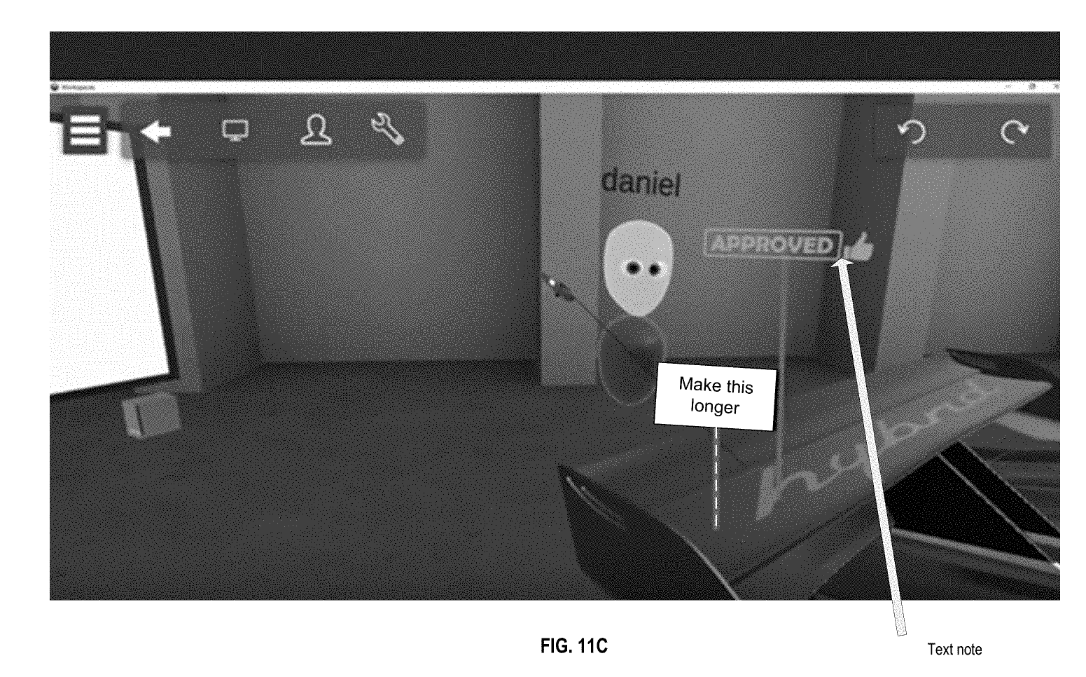

This disclosure relates to different virtual collaborative environments for adding annotations (also referred to as “notations”) to multi-dimensional virtual objects. Such annotations can include text, recorded audio, recorded video, an image, a handwritten note, a drawing, a document (e.g., PDF, Word, other), movement by the virtual object, a texture or color mapping, emoji, an emblem and other items. Once added, the annotations can be hidden from view, and later be displayed in view again. By way of example, FIG. 11A, FIG. 11B, and FIG. 11C are screen shots showing different annotations appended to a virtual object. FIG. 11A shows an annotation (e.g., a line) drawn along the fender of a virtual vehicle (virtual object). The line is drawn in orange on the screen but reproduces as a gray line in the published application. FIG. 11B is a screen shot of an annotation or journal entry (e.g., a text note) indicating a comment made by a user (“raise this line”) with a reference line to one of several (orange) lines drawn (e.g., annotated) on the fender of the virtual car shown. FIG. 11C is a screen shot of the rear portion of the virtual car of FIG. 11A and FIG. 11B having multiple annotations. An avatar of a user is shown positioned behind the virtual car with the label “Daniel.” The screen shot of FIG. 11C depicts an annotation journal entry (“make this longer”) and a text note having an annotation (“Approved”) inserted by a user. The text note (“approved”) can include a graphic (e.g., a “thumbs up,” as shown) that is inserted from another file.

In some embodiments, when a user wants to add an annotation to a virtual object, the user directs the tool (e.g., handheld controller, finger, eye gaze, or similar means) to intersect with the virtual object, the intersection is detected, and the user is provided a menu to draw or attach. The menu options may be programmable into a controller, or provided a virtual menu that appears when the intersection occurs.

If the user selects the option to draw, intersecting positions of the tool with parts of the virtual object over time are recorded as a handwritten drawing until annotational drawing is no longer desired (e.g., the user selects an option to stop drawing, or directs the tool away from the virtual object so it no longer intersects the virtual object). If the user is drawing on the virtual object, the movement is captured, a visual representation of the movement is provided in a selected color to different users, and the drawing is recorded for later viewing with the virtual object. For example, if the user draws a line, the movement of the user's hand or drawing tool is captured, and a line displays on the virtual object where the tool intersected with the virtual object. A user may also have the option to draw shapes on the virtual object (e.g., squares, circles, triangles, arcs, arrows, and other shapes).

If the user selects the option to attach an item, the user is provided with subsequent options to attach an audio, video, picture, text, document or other type of item. By way of example, the user can record a message, use speech-to-text to create a text annotation, attach a previously captured video or document, or perform another action and attach it to the virtual object at the point where the tool intersected the virtual object.

In some embodiments, the item of an annotation can be first selected and then dragged and dropped to a point of the virtual object (e.g., where the tool intersects the virtual object). In this scenario, user selection of the item is detected, and a point of the virtual object that intersects with the item after the user moves and releases the item is determined and recorded as the location of the annotation that contains the item. If the item is released at a point that is not on the virtual object, then the item may return to its previous position before it was moved.

Intersections may be shown to the user by highlighting the points of intersection, which enables the user to better understand when an intersection has occurred so the user can create an annotation. Different variations of what constitutes an intersection are contemplated. In one example of intersection, the tool intersects the virtual object when a point in a virtual environment is co-occupied by part of the tool and by part of the virtual object. In another example of intersection, the tool intersects the virtual object when a point in a virtual environment occupied by part of the tool is within a threshold distance from a point in a virtual environment occupied by part of the virtual object. The threshold distance can be set to any value, but is preferably set to a small enough value so the locations of all (or selected) annotations appended to a virtual object appear on the virtual object when viewed from different angles in the virtual environment. In some embodiments the distance can be one to ten pixels.

Users may also undo any attachment or drawing on a virtual object. Users may also create a local copy of an annotation before the annotation is exported elsewhere for permanent storage or later display to any user viewing the virtual object.

In some embodiments, restrictions are placed on whether a user can create a type of notation based on the type of virtual object (e.g., whether the virtual object supports drawing on its surface, or movement), the type of user (e.g., whether the user is authorized to create an annotation), the type of user device (e.g., whether user inputs are available to create the type of notation), the type of dimensional depiction of the virtual object (e.g., drawing is not available when a three-dimensional virtual object is displayed to a user in two-dimensions), a type of (network) connection (e.g., where a slow or limited connection does not allow a user to make certain notations that require data transfer in excess of what is supported by the connection), or other types of conditions.

In some embodiments, restrictions are placed on whether a user can view or listen to a type of notation based on the type of user (e.g., whether the user is authorized to view or listen to an annotation), the type of user device (e.g., whether user device outputs are available to provide the type of notation), the type of dimensional depiction of the virtual object (e.g., whether notations on three-dimensional virtual objects can be displayed to a user in two-dimensions), a type of connection (e.g., where a slow or limited connection does not allow a user to view or listen to certain notations that require data transfer in excess of what is supported by the connection), or other types of conditions.

In some implementations of embodiments described herein, each annotation may later appear at the points of the virtual object where the tool intersected with the virtual object even if the position or orientation of the virtual object changes in a virtual environment, or if the virtual object is viewed from another pose (position and orientation) of a user (or the associated avatar) within the virtual environment. In some embodiments, the annotation can scale with scaling of the virtual object. In some other embodiments, the annotation can remain the same size relative to the display of the user devise when the virtual object is scaled within the display.

It is noted that the user of a VR/AR/MR/XR system is not technically “inside” the virtual environment. However the phrase “perspective of the user” or “position of the user” is intended to convey the view or position that the user would have (e.g., via the user device) were the user inside the virtual environment. This can also be the “position of” or “perspective the avatar of the user” within the virtual environment. It can also be the view a user would see viewing the virtual environment via the user device.

Attention is now drawn to the description of the figures below.

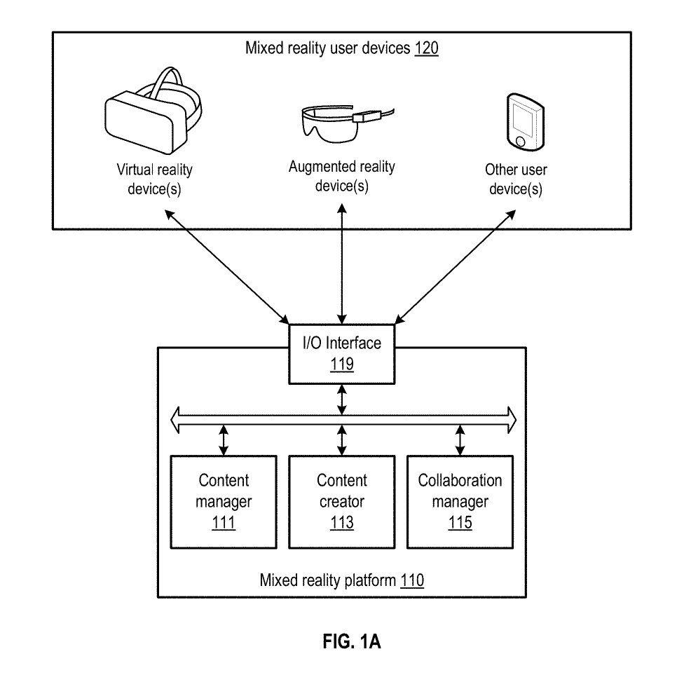

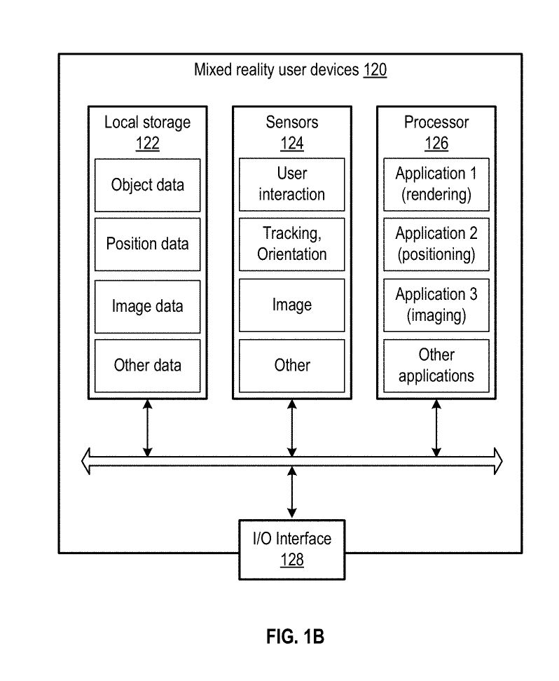

FIG. 1A and FIG. 1B are functional block diagrams of embodiments of a system for transmitting files associated with a virtual object to a user device. The transmitting can be based on different conditions. A system for creating computer-generated virtual environments and providing the virtual environments as an immersive experience for VR and AR users is shown in FIG. 1A. The system includes a mixed reality platform 110 that is communicatively coupled to any number of mixed reality user devices 120 such that data can be transferred between them as required for implementing the functionality described in this disclosure. The platform 110 can be implemented with or on a server. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 111 creates a virtual environment and visual representations of things (e.g., virtual objects and avatars) that can be displayed in a virtual environment depending on a user's point of view. Raw data may be received from any source, and then converted to virtual representations of that data. Different versions of a virtual object may also be created and modified using the content creator 111. The content manager 113 stores content created by the content creator 111, stores rules associated with the content, and also stores user information (e.g., permissions, device type, or other information). The collaboration manager 115 provides portions of a virtual environment and virtual objects to each of the user devices 120 based on conditions, rules, poses (e.g., positions and orientations) of users in a virtual environment, interactions of users with virtual objects, and other information. The I/O interface 119 provides secure transmissions between the platform 110 and each of the user devices 120. Such communications or transmissions can be enabled by a network (e.g., the Internet) or other communication (local or otherwise) link coupling the platform 110 and the user device(s) 120.

Each of the user devices 120 include different architectural features, and may include the features shown in FIG. 1B, including a local storage 122, sensors 124, processor(s) 126, and an input/output interface 128. The local storage 122 stores content received from the platform 110, and information collected by the sensors 124. The processor 126 runs different applications needed to display any virtual object or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of such peripherals include head-mounted displays, AR glasses, and other peripherals.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine view areas, and the view area is used to determine what virtual objects to render using the processor 126 for presentation to the user on a display of a user device. Tracking the positions and orientations of the user or any user input device (e.g., a handheld device) may also be used to determine interactions with virtual objects. In some embodiments, an interaction with a virtual object includes a modification (e.g., change color or other) to the virtual object that is permitted after a tracked position of the user or user input device intersects with a point of the virtual object in a geospatial map of a virtual environment, and after a user-initiated command is provided to make the desired modification.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual objects among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

The methods or processes outlined and described herein and particularly those that follow below, can be performed by one or more processors of the platform 110 either alone or in connection or cooperation with the user device(s) 120. The processes can also be performed using distributed or cloud-based computing.

### Adding Notations to Virtual Objects in a Virtual Environment

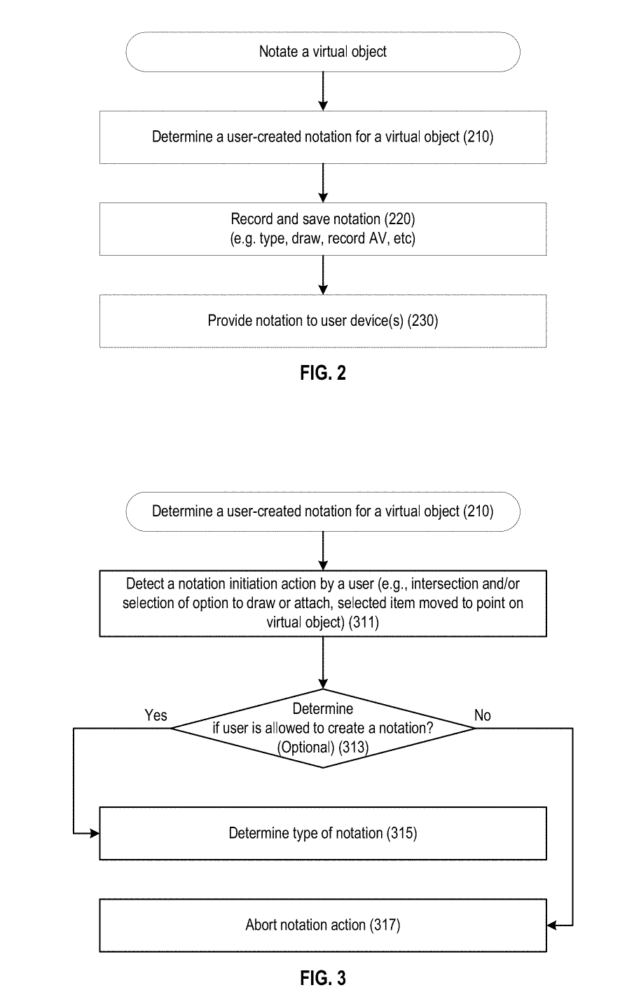

FIG. 2 is a flowchart of a process for notating on virtual objects and providing the annotations to user devices for display or playback. The process starts by determining that a user has initiated an action to create an annotation on a virtual object (210) via a user device. Once the annotation has been created, the annotation is recorded and saved in as part of a virtual object (220). Next, the annotation is shared with other users (230) via a network (e.g., LAN, WAN).

FIG. 3 is a flowchart of a process for determining a user-created notation for a virtual object during step 210. An annotation initiation action by a user can be detected (311) by the platform 110, for example. Examples of notation initiation actions include moving a tool to intersect a virtual object and/or selecting an option to draw or attach an annotation item, or selecting an annotation item and moving it to a point on virtual object. Known approaches may be used to detect these actions. Optionally, the process may determine if the user is allowed to create an annotation (313)—e.g., based on permissions or other conditions. In other embodiments of step 210, this determination may occur before step 311, after other steps in FIG. 3, or at any time before, during, and after the creation of an annotation. If the user is allowed to create an annotation, the type of notation being created is determined (315). Otherwise, if the user is not allowed to create an annotation, the system will abort the annotation action (317). In some embodiments, step 315 is carried out before step 313.

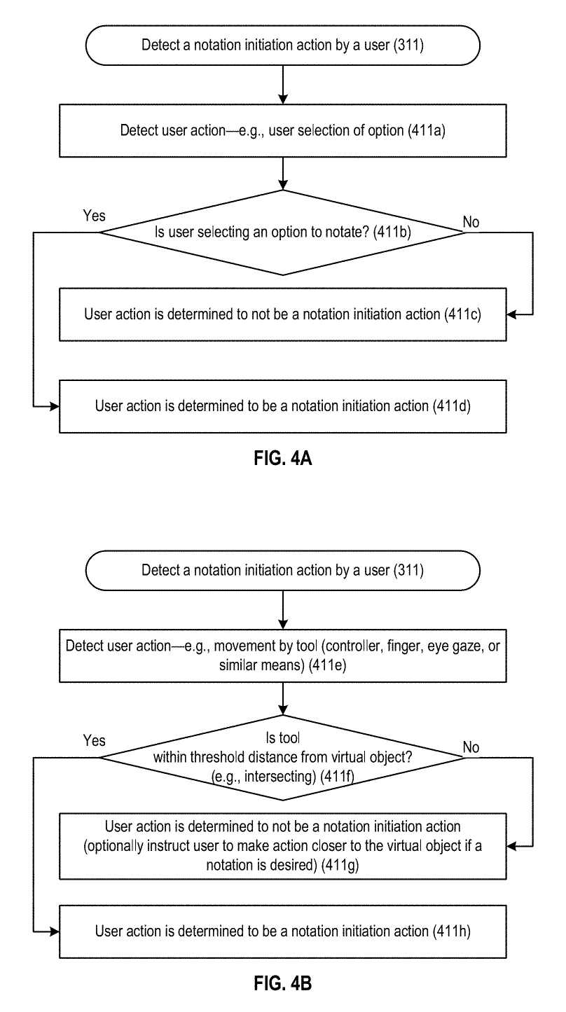

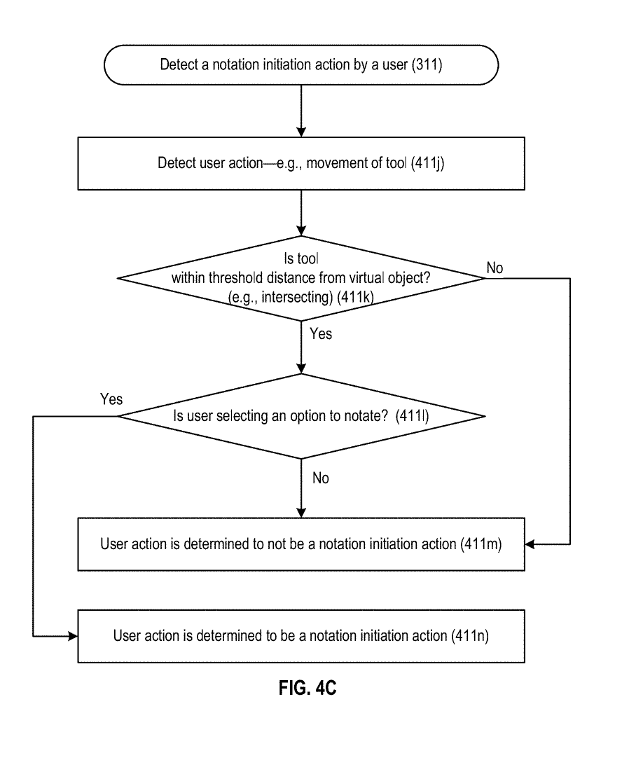

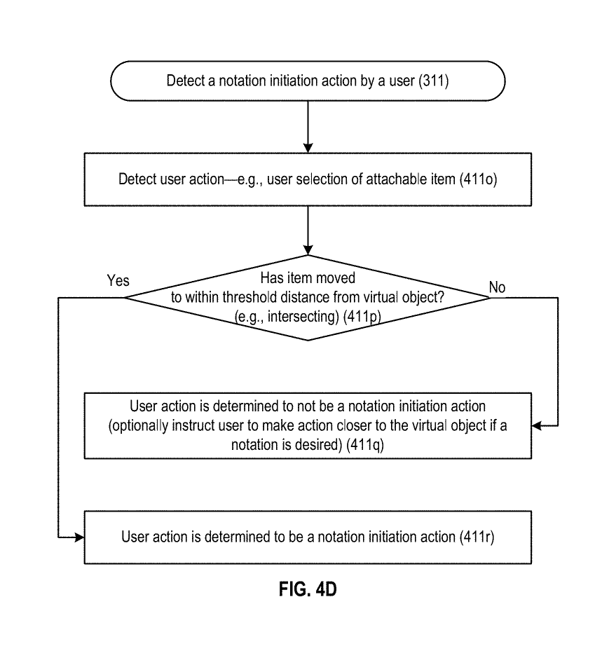

FIG. 4A through FIG. 4D each depict a different process for detecting an annotation initiation action by a user during step 311.

FIG. 4A is a flowchart of an embodiment of a process for managing an annotation action. A user action is detected (411a) by the platform 110—e.g. user selection of option. A determination is made as to whether the user is selecting an option to notate (411b). If the user is not selecting an option to notate, the user action is determined to not be an annotation initiation action (411c). If the user is selecting an option to notate, the user action is determined to be an annotation initiation action (411d).

FIG. 4B is a flowchart of another embodiment of a process for managing an annotation action. A user action is detected (411e)—e.g. movement by tool (controller, finger, eye gaze, an avatar representing the user, or similar means). A determination is made as to whether the tool is within a threshold distance from a virtual object (e.g., intersecting with the virtual object) (411f). If the tool is not within the threshold distance, the user action is determined to not be an annotation initiation action (411g). An optional instruction may be generated to instruct the user to move the tool closer to the virtual object if an annotation is desired. If the tool is within the threshold distance, the user action is determined to be an annotation initiation action (411h). Different threshold distances between a point in the virtual environment occupied by the tool and a point in the virtual environment occupied by the virtual object can be used. One example includes a straight linear distance between the points, a vector distance from one of the points to the other point, or other threshold determinations where the location of the tool is measured relative to the location of the virtual object or other representation of the virtual object's location. In some embodiments such a distance can be measured in pixels.

FIG. 4C is a flowchart of another embodiment of a process for managing an annotation action. A user action is detected (411j)—e.g. movement by tool. A determination is made as to whether the tool is within a threshold distance from a virtual object (411k). If the tool is not within the threshold distance, the user action is determined to not be an annotation initiation action (411m). If the tool is within the threshold distance, a determination is made as to whether the user is selecting an option to notate (411l ). If the user is not selecting an option to notate, the user action is determined to not be an annotation initiation action (411m). If the user is selecting an option to notate, the user action is determined to be an annotation initiation action (411n).

FIG. 4D is a flowchart of another embodiment of a process for managing an annotation action. A user action is detected (411o)—e.g. user selection of attachable item. A determination is made as to whether the selected item has moved to within a threshold distance from a virtual object (e.g., intersecting with the virtual object) (411p). If the item is not within the threshold distance, the user action is determined to not be an annotation initiation action (411q). An optional instruction may be generated to instruct the user (e.g., via the user device) to move the item closer to the virtual object if an annotation is desired. If the item is within the threshold distance, the user action is determined to be an annotation initiation action (411r).

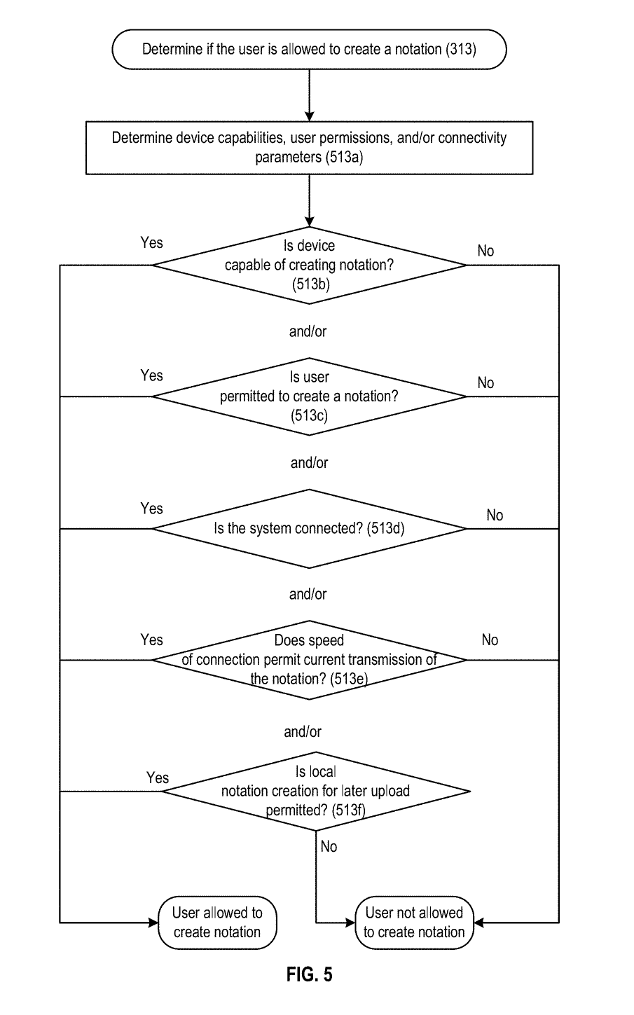

FIG. 5 is a flowchart of an embodiment of a process for determining if the user is allowed to create an annotation. The process depicted in FIG. 5 relates to the step 313 (FIG. 3). As shown in FIG. 5, one or more different conditions are determined (513a)—e.g., user device capabilities, user permissions, connectivity parameters, and/or other conditions. By way of example, any individual or combination of the following conditions can be tested: if the user device operated by the user is capable of creating an annotation (513b), if the user is permitted to create an annotation (513c), if the user device is connected (513d), if the speed of the connection permits the annotation to be transmitted or is of reasonable throughput capability to deliver the annotation over the network in a reasonable time (513e), and/or if local notation creation for later transmission is permitted (513f). If the results of test(s) are affirmative, the user is allowed to create the annotation. If the results of test(s) are negative, the user is not allowed to create an annotation.

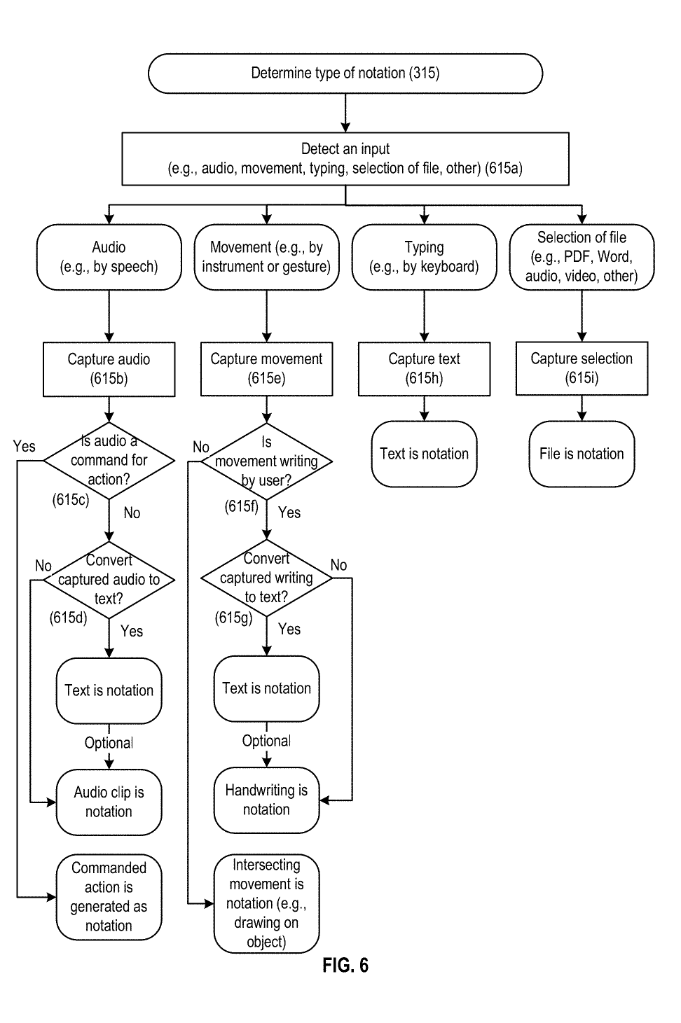

FIG. 6 is a flowchart of an embodiment of a process for determining a type of notation during step 315. As shown in FIG. 6, a user input is detected (615a), which may include detected audio, movement of a tool, typing, selection of a file, or other.

If audio (e.g., user speech) is detected, the audio is captured (615b). A determination is made as to whether the audio is a command for action (615c). If the audio is a command for action, the commanded action is generated as the annotation. As examples, the command for action could be an instruction to do something—e.g., “rotate three times” or “change color”—and the commanded action—e.g. the three rotations, the change of color—would be stored as the annotation to be carried out when the annotation is viewed or displayed. If the audio is not a command for action (e.g., is a note), a determination is made as to whether the audio is to be converted to text (615d). Any text conversion is the annotation. The audio itself may be an audio clip and treated as the annotation.

If movement (e.g., by a tool) is detected, the movement is captured (615e). A determination is made as to whether the movement (e.g., intersecting with the virtual object) is a handwritten note or a drawing (615f). If the movement is a drawing, the movement is the annotation. If the movement is a handwritten note, a determination is made as to whether the writing is to be converted to text (615g). Any text conversion is the annotation. The writing itself may be treated as the annotation. Optionally, movement may be saved as an image file, a video file (e.g. a visual playout of the movement) or other type of file consistent with the movement (e.g., a CAD file).

If typing is detected, the typed text is captured (615h) and treated as the annotation. By way of example, typing may be by a physical or virtual keyboard, by verbal indication of the letters, or other forms of typing.

If selection of a file is detected, the selected file is captured (615i) and treated as the annotation. Examples of files include documents (e.g., PDF, Word, other), audio files, video files, image files, and other types of files.

Each vertical sub-flow under step 615a may not be performed in each embodiment of FIG. 6. Also each step in a particular vertical sub-flow need not be performed in each embodiment of FIG. 6.

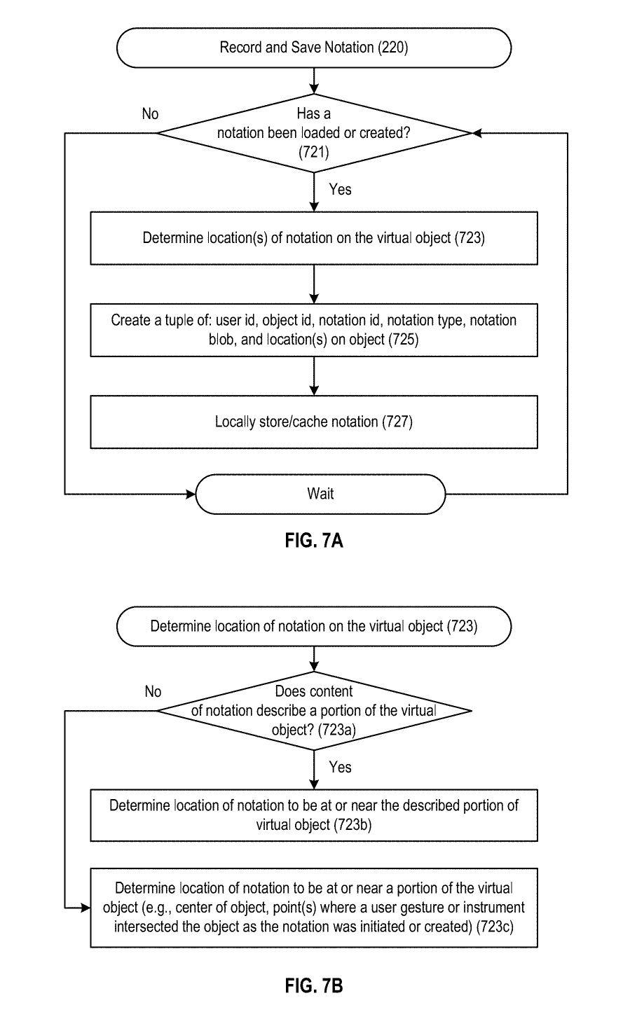

FIG. 7A and FIG. 7B are flowcharts of processes for recording and saving an annotation.

In FIG. 7A, a determination is made as to whether the annotation has been loaded or created (721). If the annotation has not been created or loaded, the process waits until creation or loading is complete. If the annotation has been created or loaded, the location(s) of the annotation are determined (723). By way of example, the location(s) may include the location of the intersection from steps 411e-f of FIG. 4B, or another point designated by the user where the user provides an input designating the location via speech, text, selection or other input. A tuple is created (725), which may include the following of data: user ID, object ID, notation ID, notation type, notation blob, and/or location on object or location in virtual environment. An annotation blob is a set of data that represents the annotation itself. Finally, the location(s) and/or tuple of data is locally stored or cached (727).

FIG. 7B describes how the location of an annotation on a virtual object is optionally determined during step 723. A determination is made as to whether content of the annotation describes a portion of the virtual object (723a). If content of the annotation describes a portion of the virtual object, the location of the annotation is determined to be at or near the described portion of the virtual object (723b). If content of the annotation does not describe a portion of the virtual object, the location of the annotation is determined to be at or near the a predefined portion of the virtual object (723c)—e.g., center of a surface of the virtual object, point(s) where a tool intersected the virtual object as the annotation was initiated, a pre-designated portion of the virtual object, or other. An example of content that describes a portion of the virtual object includes audio or text that identifies the portion of the virtual object—e.g., if the annotation content is “the roof of this car should be painted blue”, then a location of the annotation is determined to be a point on the roof of the virtual car.

Any location of an annotation may be highlighted to indicate that an annotation is available for selection and/or activation at that location.

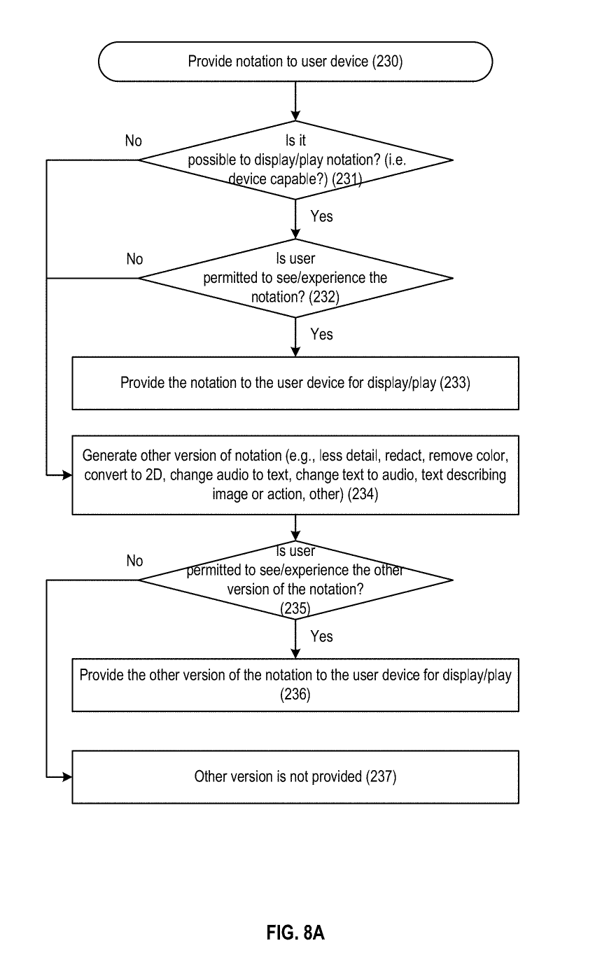

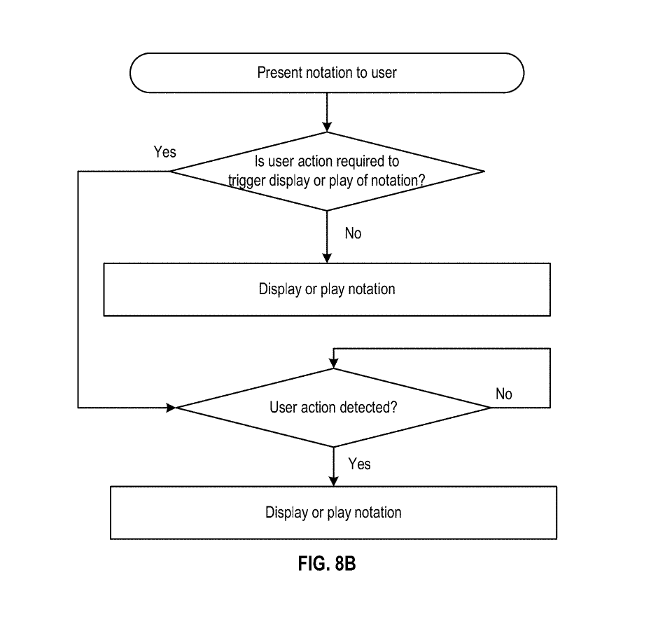

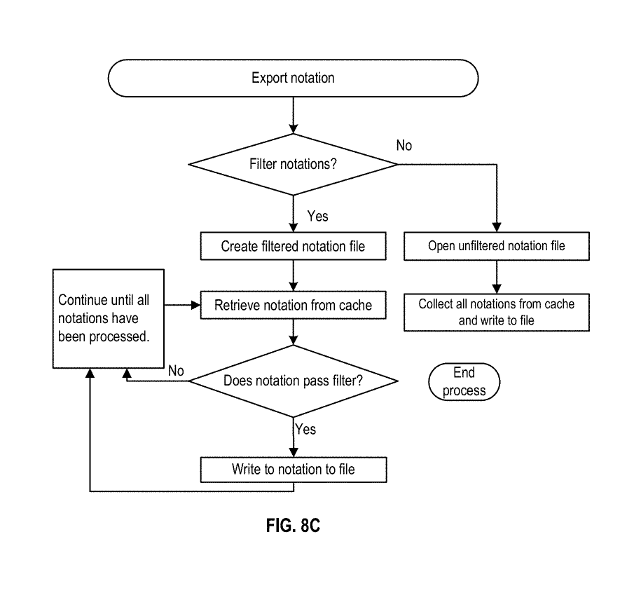

FIG. 8A is a flowchart of an embodiment of a process for providing an annotation to a user device. The process of FIG. 8A can be applied during step 230 (FIG. 2), rendering an annotation, and exporting an annotation. As shown in FIG. 8A, a determination is made as to whether it is possible to display/play the original version of the annotation using a particular user device (231). If it is possible to display/play the original version of the annotation using a particular user device, a determination is made as to whether the user is permitted to see/experience the original version of the annotation (232). If the user is permitted to see/experience the original version of the annotation, the original version is provided to the user device of the user (233). If the user is not permitted to see/experience the original version of the annotation, process proceeds to step 234. If it is not possible to display/play the original version of the annotation using a particular user device, or if the user is not permitted to see/experience the original version of the annotation, another version of the annotation may be generated (234). By way of example, the other version may include less detail, redacted portions of the annotation, removed color/texture, fewer or no animations, a two-dimensional representation of a three-dimensional notation, transcription of audio to text or vice versa, replacement of a visual depiction or action with a written description of the visual depiction or action, or other). A determination is made as to whether the user is permitted to see/experience the other version of the annotation (235). If the user is permitted to see/experience the other version of the annotation, the other version is provided to the user device of the user (236). If the user is not permitted to see/experience the other version of the annotation, the version is not provided to the user device of the user (237). Step 234 through step 237 may be repeated for different versions until a version that the device can render and that the user is permitted to see/experience is generated (if possible). It should also be appreciated that, in some embodiments, the negative results from steps 231 and 232 may proceed directly to a step of not providing any version (not shown).

FIG. 8B is a flowchart of an embodiment of a process for presenting an annotation to a user. As shown, a determination is made as to whether user action required to trigger display or play of the annotation. If a user action is not required, the annotation is automatically displayed or played. If a user action is required, the annotation is displayed or played only after user action is detected. User action may be required if the natural form of the annotation is bigger than the user's viewing area or a display region for an annotation, if the annotation is of a type that may be disruptive or unwanted by the user (e.g., an audio or video file playing at an inopportune, or the size/scope of notation overlaid in front of the virtual object would disrupt the user's view of the virtual object), or if the current position of or visual perspective of the virtual object does not allow for the presentation of the annotation in the current viewing area for the user (e.g., a text notation on the roof of a car when the perspective of the virtual car doesn't show the roof). In some embodiments when the current position of or visual perspective of the virtual object does not allow for the presentation of the annotation in the current viewing area for the user, the annotation may be displayed in a way so it can be seen by the user. User actions to trigger display/playout may include one or more of the following: a verbal command, tool intersection with the virtual object or tool intersection with the visual depiction of the annotation, eye/gaze detection directed towards the virtual object or the annotation, a custom button/input that is triggered, or others.

FIG. 8C is a flowchart of an embodiment of a process for exporting notations to a user. A determination is made as to whether existing notations are to be filtered. In some embodiments, notations or annotation can be saved to the same virtual object over time by a plurality of users. Therefore, a given user may only want to view certain annotations or certain categories of annotations, or annotation included by a certain user or for a certain reason, or within a certain period of time. The filters described in connection with FIG. 8C can allow limiting the view of some annotations to specific criteria indicated by a given user. By way of example, filters may be based on user id, object id, object type, annotation type, or other stored types of data. If existing annotations are not to be filtered, an unfiltered annotation file is opened, and all annotations from memory or cache can be collected and written to the unfiltered annotation file. If existing notations are to be filtered, a filtered annotation file is opened, individual annotations from cache are retrieved, and retrieved annotations that pass the filter are written to the filtered notation file.

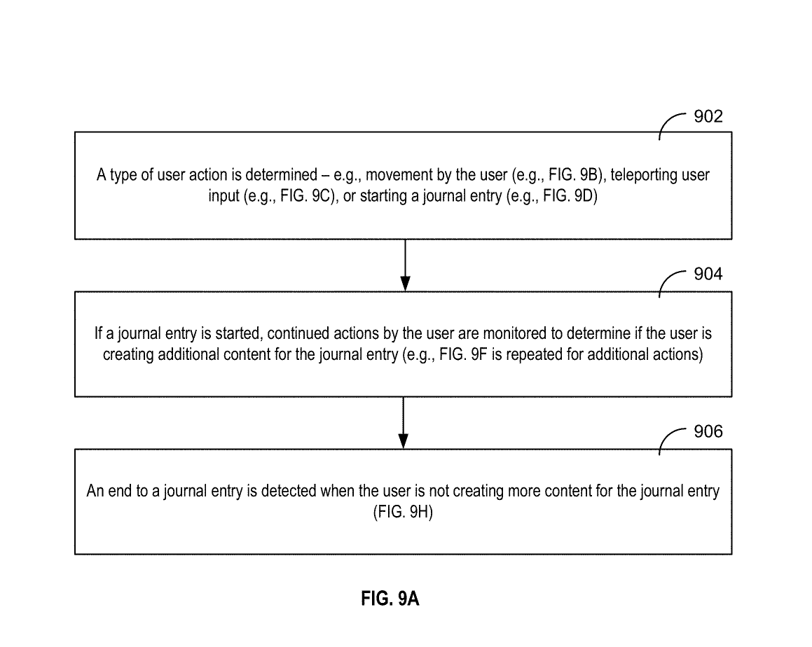

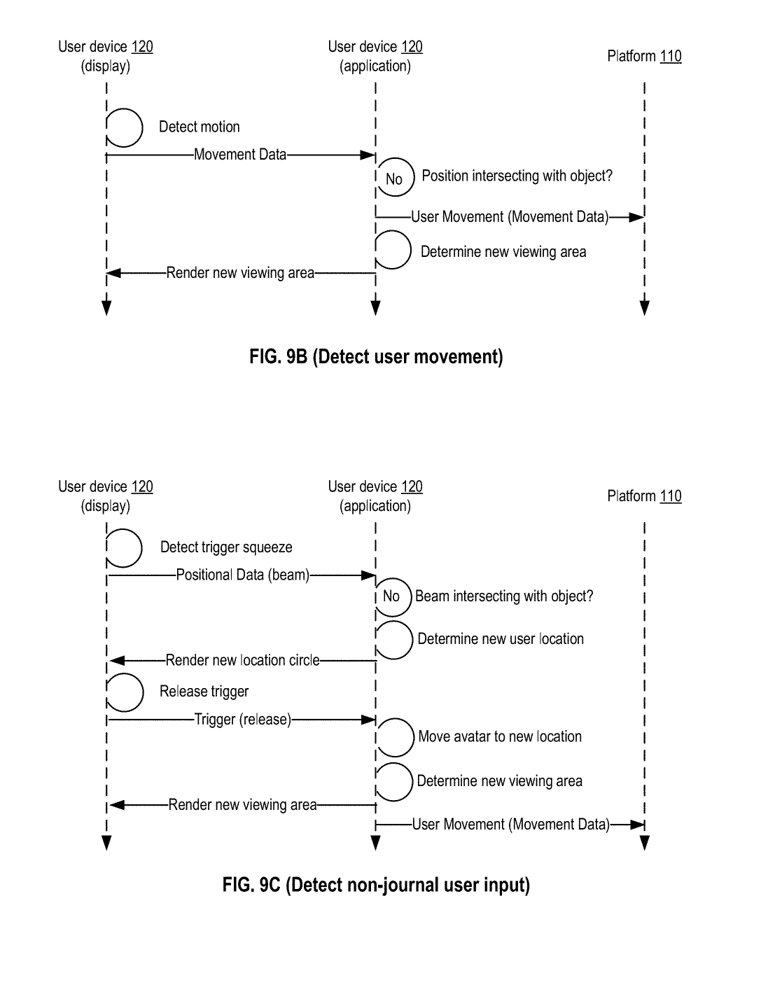

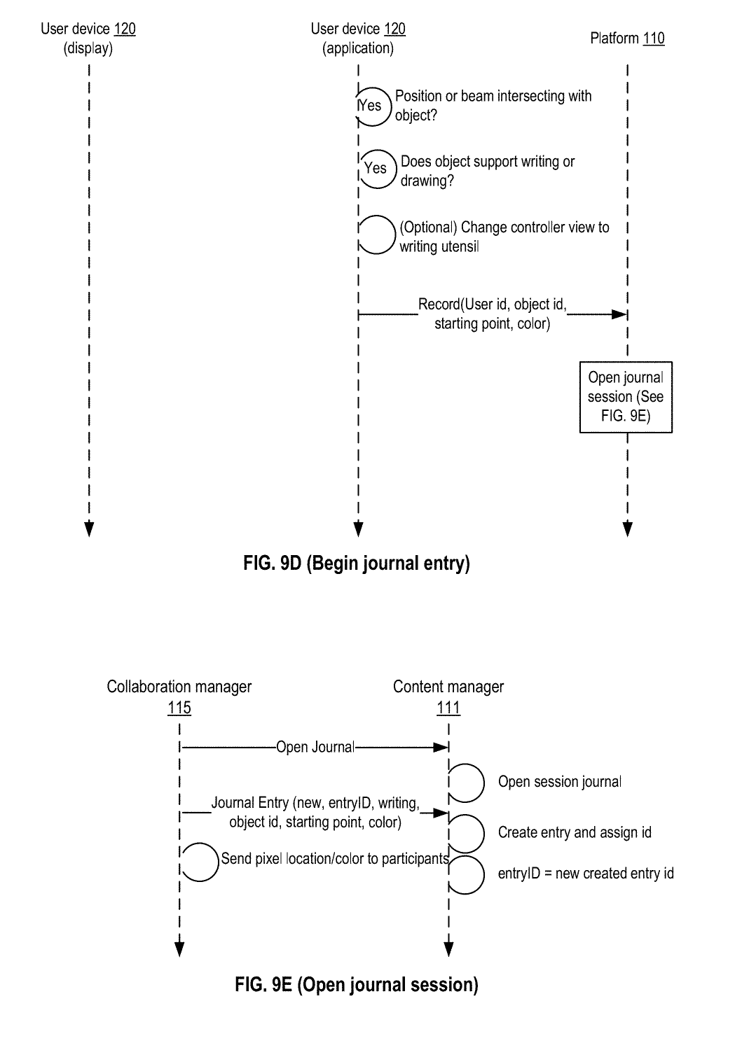

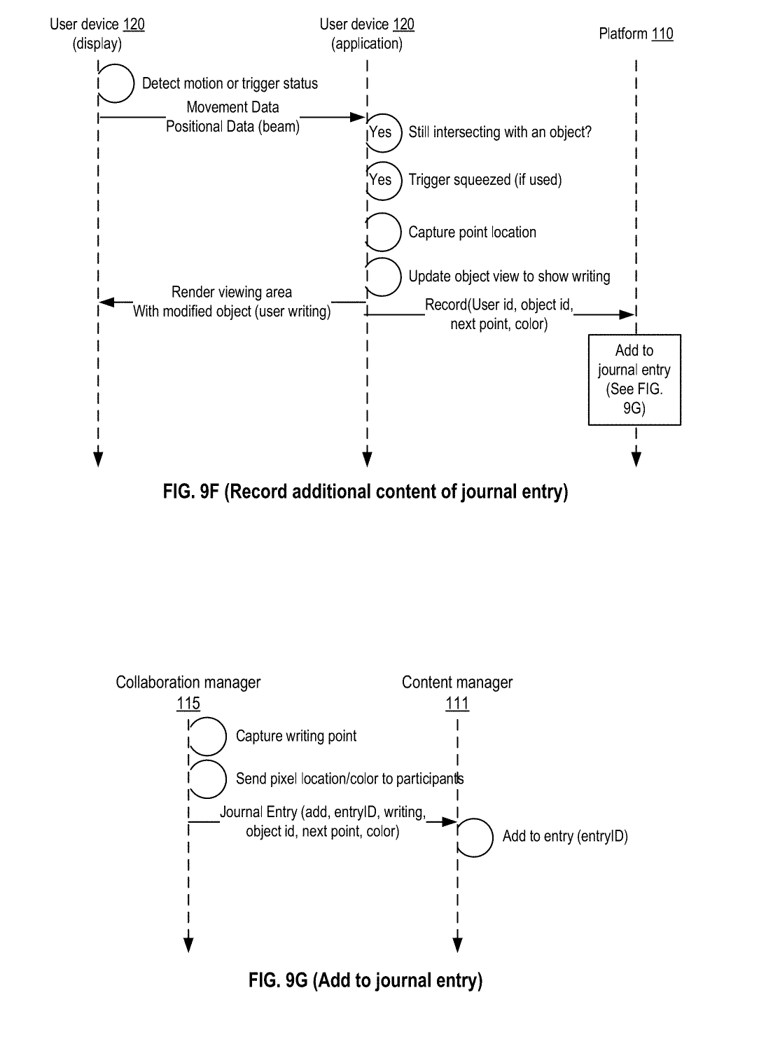

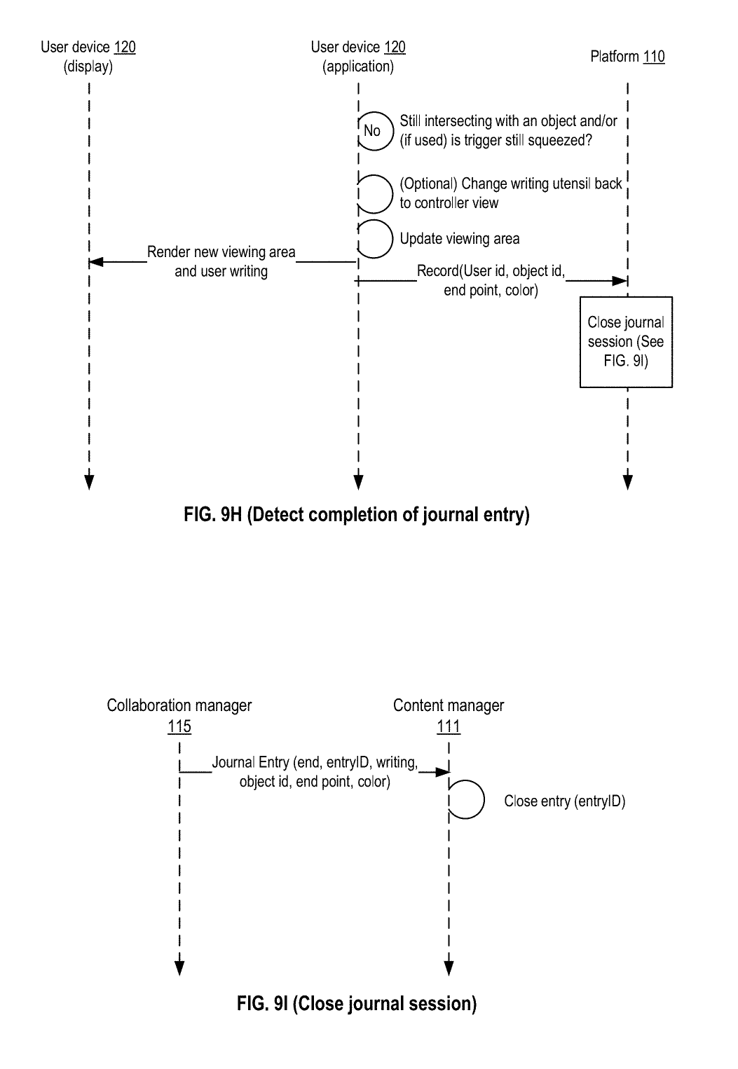

FIG. 9A is a flowchart of an embodiment of a method for detecting and capturing a journal entry in a virtual environment. As used herein, a journal entry can be any recording or writing that describes an action or thing. The journal entry can generally be associated with a timestamp or other relative indication of when the journal entry was recorded, written, or saved. Journal entries (and all annotations more generally) can be saved in four dimensions. The four dimensions can be a set of x, y, z, coordinates (e.g., length, width, and height) within the virtual environment (in connection with a virtual object) associated with a time. The method may also be used to capture an annotation drawing. As shown in FIG. 9A, a type of user action is determined (902)—e.g., movement by the user (e.g., FIG. 9B), teleporting of the user to a new position (e.g., FIG. 9C), or starting a journal entry (e.g., FIG. 9D). If a journal entry is started (904), continued actions by the user are monitored to determine if the user is creating additional content for the journal entry (e.g., FIG. 9F is repeated for additional actions). Finally, an end to a journal entry is detected when the user is not creating additional content for the journal entry (906) (FIG. 9H). The method results in reduced resource use by limiting the size of a journal entry. Monitored actions that indicate the user is creating additional content for a journal entry can be combined and saved in a single journal entry, while a single action that indicates the user has created a journal entry without additional content can be saved as its own journal entry.

In some embodiments, the start of a journal entry is determined when a user selects a option that allows the user to create a journal entry, and also selects the virtual object with which the journal entry is to be associated. In other embodiments, the start of a journal entry is determined when a virtual position of the user (or a tool used by the user) intersects with a virtual object, and any continued intersections are interpreted as continued actions indicative of the user creating additional content for the journal entry. In some implementations, a journal entry is not started until a user command (e.g., a trigger pull of a mechanical tool, voice command or other) is received in addition to determining that the virtual position intersects with the point on the virtual object. One embodiment of intersection includes the virtual position intersecting a point on the virtual object. Another embodiment of intersection includes the virtual position intersecting a point in the virtual environment that is within a threshold distance from the virtual object (so virtual position does not need to exactly intersect with a point on the virtual object). As noted above, the journal entries (or the annotations, more generally) can be tracked in four dimensions for viewing by all users viewing the associated virtual object.

FIG. 9B is a flowchart of an embodiment of a sub-process for detecting user movement of FIG. 9A. The method of FIG. 9B can be used in step 902 of FIG. 9A. As shown, motion from one position to a new position in the virtual environment by the user or a tool is detected. The new position is compared to positions of points on a virtual object to determine if the new position is intersecting any point on the virtual object. If the new position is not intersecting any point on the virtual object, the new position is recorded and used to determine a new viewing area for the user. For details about next steps after the new position is found to intersect a point on the virtual object, please refer to FIG. 9D.

FIG. 9C is a flowchart of an embodiment of a sub-process for detecting whether a user is teleporting to a new position of FIG. 9A. The method of FIG. 9C can be used in step 902 of FIG. 9A. Other types of user input for other purposes can also be monitored. As shown, a trigger squeeze is detected. The trigger squeeze may emit a positional beam or type of reference indicator into the virtual environment. If the positional beam does not intersect a virtual object, a new location circle is rendered for view by the user. If the trigger is released, the position of the user is moved to the position of the new location circle, and used to determine and render a new viewing area for the user. For details about next steps after the positional beam is found to intersect the virtual object, please refer to FIG. 9D.

FIG. 9D is a flowchart of an embodiment of a sub-process for determining when a journal entry starts (e.g., the next steps after a new position is found to intersect a point on the virtual object during FIG. 9B and/or after a positional beam is found to intersect the virtual object during FIG. 9C). Any new viewing area may be determined and rendered for display to the user as needed. As shown in FIG. 9D, a determination is made as to whether a journal entry can be created for the virtual object, or created by the user. If not, no journal entry is allowed. If a journal entry can be created for the virtual object and by the user, a depiction of the tool in view of the user is optionally changed to a writing utensil to alert the user he or she can begin a journal entry. Different data is recorded, including an ID of the user, an ID of the virtual object, a starting point (e.g., the point of intersection) of the journal entry, and a color of the journal entry at the starting point. The sub-process proceeds to opening a journal entry session, as shown in FIG. 9E, which includes opening a session journal entry, and storing data for the journal entry (e.g., a journal entry identifier, the starting point and its color, the ID of the virtual object, among other data). The pixel location of the starting point and its color are also sent to any other user devices for display to users of those devices if the starting point is in view of those users.

FIG. 9F is a flowchart of an embodiment of a sub-process for determining if the user is creating additional content for an existing journal entry. As shown, motion from one position to a new position in the virtual environment by the user, a tool operated by the user, or a positional beam is detected. Alternatively, a trigger release or squeeze may be detected (if used). If the new position does not intersect a point on the virtual object or if the trigger is released (when in use), the steps of FIG. 9H are followed to end the journal entry. If the new position is found to intersect a point on the virtual object, and if the trigger is still squeezed (when in use), the location of the intersection is recorded, a view of the virtual object in a viewing area of the user is updated to show a pixel color representing the journal entry at the point of intersection, and additional data is recorded, including the ID of the user, the ID of the virtual object, a next point (e.g., the current point of intersection) of the journal entry, and a color of the journal entry at the next point. The sub-process proceeds to adding to an open journal entry session, as shown in FIG. 9G, which includes storing new data for the journal entry (e.g., the journal entry identifier, the next point and its color, the ID of the virtual object, among other data). The pixel location of the next point and its color are also sent to any other user devices for display to users of those devices if the starting point is in view of those users.

FIG. 9H is a flowchart of an embodiment of a sub-process for determining when an end to a journal entry is detected. As shown, if the new position does not intersect a point on the virtual object, or if the trigger is released (when in use), the depiction of the tool in view of the user is optionally changed to a controller or other image to alert the user the journal entry has ended. Any new viewing area may be determined and rendered for display to the user as needed. Data indicating the end of the journal entry is generated and stored, including the ID of the user, the ID of the object, an end point of the journal entry, and the color of that end point. The sub-process proceeds to closing the journal session, as shown in FIG. 91, which includes storing final data for the journal entry (e.g., the journal entry identifier, the end point and its color, the ID of the virtual object, among other data). The stored data may be later retrieved and displayed at the stored points.

The methods shown in FIG. 9A through FIG. 91 may also be used for notations (e.g., drawings) instead of journal entries (e.g., by replacing “journal entry” with “notation” or “drawing”).

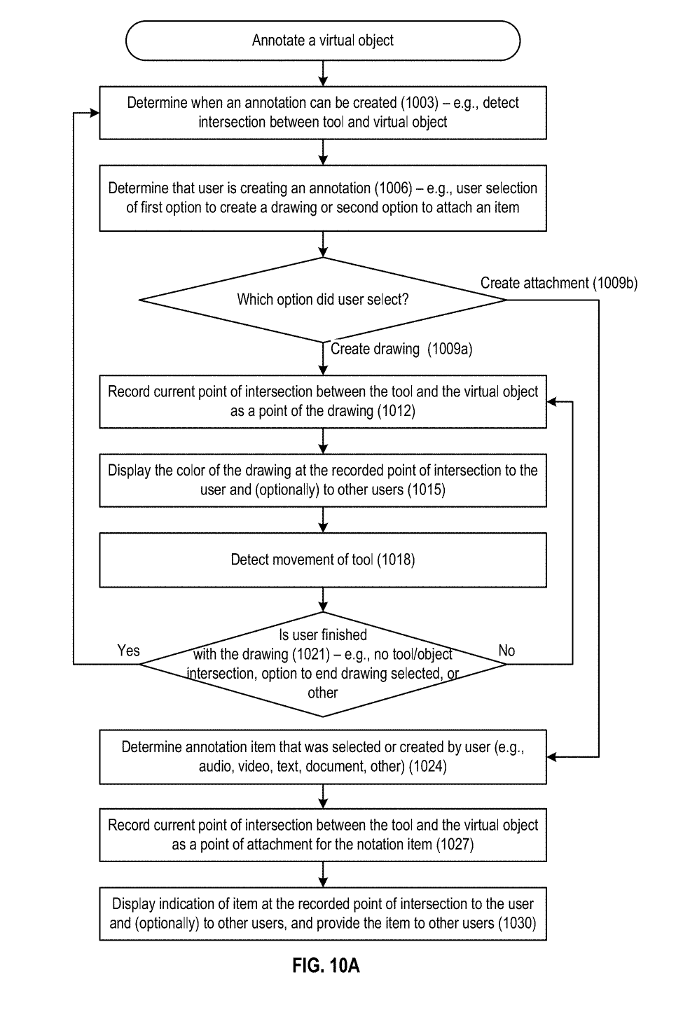

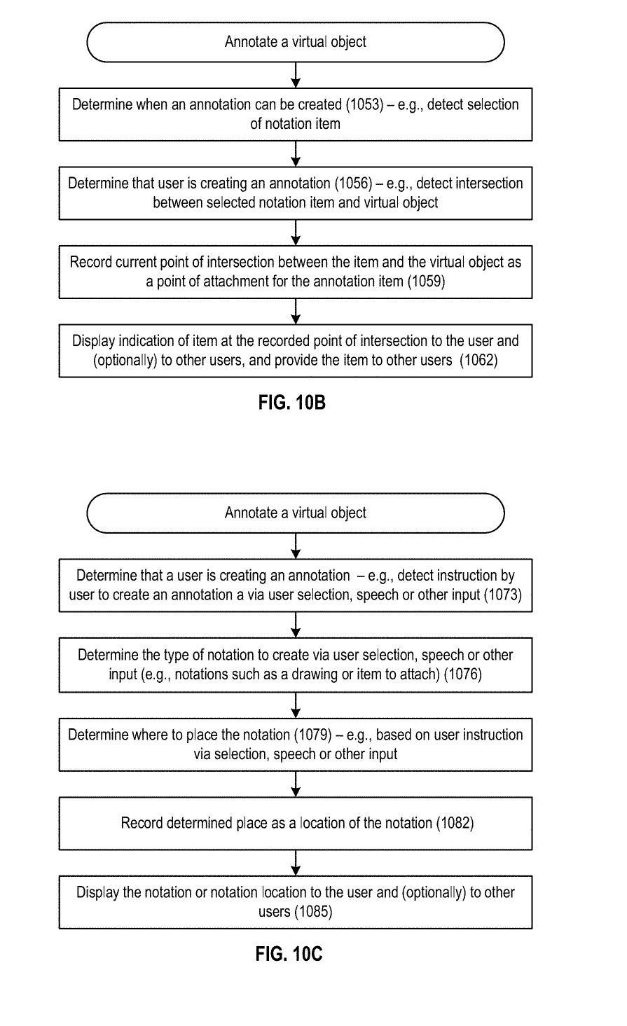

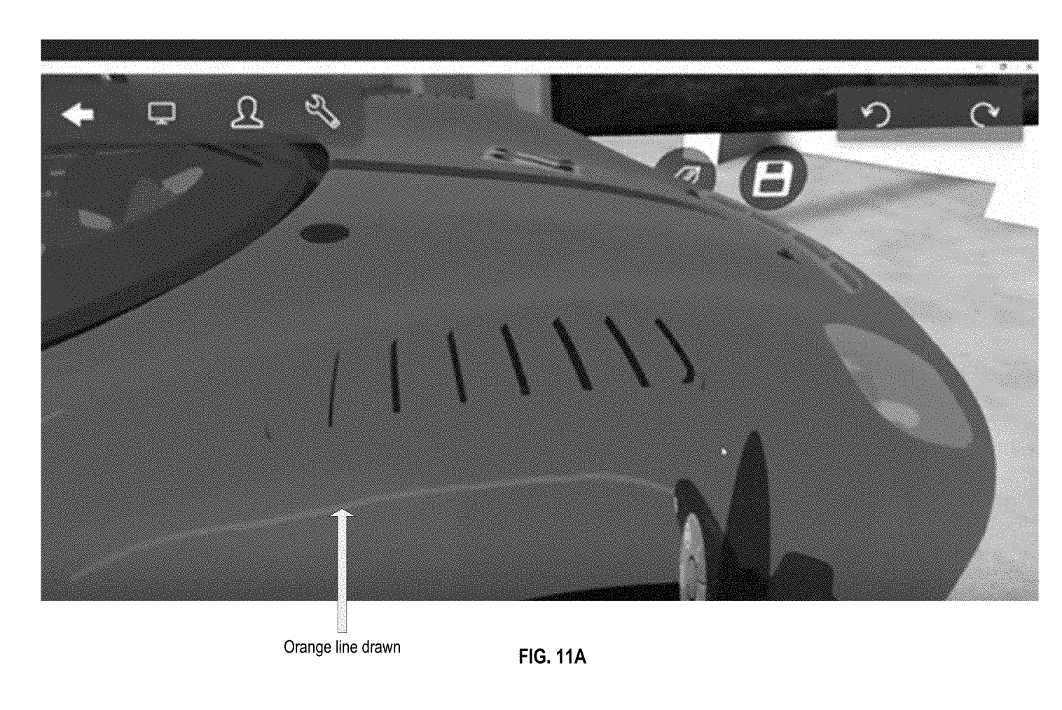

FIG. 10A through FIG. 10C are flowcharts of embodiments of methods for detecting, capturing and displaying an annotation.

As shown in FIG. 10A, a determination is made as to when an annotation can be created (1003)—e.g., by detecting an intersection between tool and virtual object. A determination is then made that a user is creating an annotation (1006)—e.g., by detecting user selection of a first option to create a drawing, or a second option to attach an item.

When the user selection is to create a drawing (1009a), the current point of intersection (e.g., intersection point) between the tool and the virtual object is recorded as a point of the drawing (1012), the color of the drawing is displayed at the recorded point of intersection to the user and (optionally) to other users (1015), and a determination is made as to whether the user is finished with the drawing (1021)—e.g., no tool/object intersection, option to end drawing selected by user, or other. If the user is finished with the drawing, the process returns to step 1003. If the user is not finished with the drawing, the process returns to step 1012.

When the user selection is to attach an annotation item (1009b), a selected or created annotation item is determined (1024)—e.g., selection or creation of an audio, video, text, document, other file. The current point of intersection between the tool and the virtual object is recorded as a point of attachment for the annotation item (1027). The current point of intersection can thus be saved to memory, for example. An indication of the annotation item or the annotation item itself is displayed at the recorded point of intersection to the user and (optionally) to other users, and the annotation item is made available to the other users if not already displayed or experienced (1030).

As shown in FIG. 1013, a determination is made as to when an annotation can be created (1053)—e.g., by detecting selection of an annotation item. A determination is then made that a user is creating an annotation (1056)—e.g., by detecting intersection between selected annotation item and virtual object. The current point of intersection of the annotation item and the virtual object is recorded as a point of attachment for the annotation item (1059). An indication of the annotation item or the annotation item itself is displayed at the recorded point of intersection to the user and (optionally) to other users, and the annotation item is made available to the other users if not already displayed or experienced (1062).

As shown in FIG. 100, a determination is made that a user is creating an annotation (1073)—e.g., by detecting an instruction by the user to create an annotation via user selection, speech or other input from the user. The type of notation to create is determined via user selection, speech or other input by the user (1076). Examples of types of notations include a drawing or an annotation item to attach. A determination is made as to where to place the annotation (1079)—e.g., based on user instruction via selection, speech or other input by the user. The determined place is recorded as a location of the annotation (1082), and the annotation or notation location is displayed to the user and (optionally) to other users (1085).

Virtual environments and virtual objects may be presented using virtual reality (VR) technologies and/or augmented reality (AR) technologies. Therefore, notations are available using VR technologies and/or AR technologies. Notations may be made in an AR environment over a physical object by first determining a virtual representation of the physical object, and then associating the annotations with that virtual representation.

### Other Aspects

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

What is claimed is:

1. A method for adding annotations to a virtual object in a virtual environment, the method comprising:
determining, at a server, that a virtual tool within the virtual environment operated via a first user device intersects the virtual object at a first location;
receiving, at the server, an indication of a selection of an annotation option at the first user device to generate the annotation on the virtual object; and
if the indication is associated with creating a drawing,
saving the first location to the memory,
detecting movement of the tool within the virtual environment,
saving the drawing based on the movement of the tool to a memory, and
displaying, via the first user device, the drawing at the first location.

2. The method of claim 1 further comprising displaying the virtual object and the drawing via a second user device.

3. The method of claim 1 further comprising:
if the indication is associated with an attachment to the virtual object,
determining the attachment to attach to the virtual object,
saving the attachment with an association to the first location to the memory, and
displaying, via the first user device, an indication of the attachment at the location saved to memory.

4. The method of claim 3 further comprising displaying the virtual object, and one of the indication of the attachment and the drawing at the first location via a second user device.

5. The method of claim 3, wherein the attachment is one of an audio recording, a video recording, a drawing, a journal entry, and an attached file.

6. The method of claim 1 wherein the annotation is saved to the memory with four dimensional coordinates, including three physical dimensions and time.

7. The method of claim 1 wherein determining that the virtual tool intersects the virtual object at the first location comprises determining when a point in the virtual environment occupied by the part of the tool is within a threshold distance from a point in the virtual environment occupied by part of the virtual object.

8. The method of claim 7 wherein the threshold comprises a distance of one to ten pixels.

9. The method of claim 1 further comprising applying a restriction to the user device based on one of a type of the virtual object, a type of the user device a user identification, a type of dimensional depiction of the virtual object, and a type of network connection.

10. A non-transitory computer-readable medium comprising instructions for adding annotations to a virtual object in a virtual environment, that when executed by one or more processors cause the one or more processors to:
determine that a virtual tool within the virtual environment operated via a first user device intersects the virtual object at a first location;
receive an indication of a selection of an annotation option at the first user device to generate the annotation on the virtual object; and
if the indication is associated with creating a drawing,
save the first location to the memory,
detect movement of the tool within the virtual environment,
save the drawing based on the movement of the tool to a memory, and
display, via the first user device, the drawing at the first location.

11. The non-transitory computer-readable medium of claim 10 further comprising instructions causing the one or more processors to display the virtual object and the drawing via a second user device.

12. The non-transitory computer-readable medium of claim 10 further comprising instructions causing the one or more processors to:
if the indication is associated with an attachment to the virtual object,
determine the attachment to attach to the virtual object,
save the attachment with an association to the first location to the memory, and
display, via the first user device, an indication of the attachment at the location saved to memory.

13. The non-transitory computer-readable medium of claim 12 further comprising instructions causing the one or more processors to display the virtual object, and one of the indication of the attachment and the drawing at the first location via a second user device.

14. The non-transitory computer-readable medium of claim 12, wherein the attachment is one of an audio recording, a video recording, a drawing, a journal entry, and an attached file.

15. The non-transitory computer-readable medium of claim 10 wherein the annotation is saved to the memory with four dimensional coordinates, including three physical dimensions and time.

16. The non-transitory computer-readable medium of claim 10 wherein causing the one or more processors to determine that the virtual tool intersects the virtual object at the first location comprises causing the one or more processors to determine when a point in the virtual environment occupied by the part of the tool is within a threshold distance from a point in the virtual environment occupied by part of the virtual object.

17. The non-transitory computer-readable medium of claim 16 wherein the threshold comprises a distance of one to ten pixels.

18. The non-transitory computer-readable medium of claim 10 further comprising instructions causing the one or more processors to apply a restriction to the user device based on one of a type of the virtual object, a type of the user device a user identification, a type of dimensional depiction of the virtual object, and a type of network connection.

19. A method for adding annotations to a virtual object in a virtual environment, the method comprising:
determining, at a server, that a virtual tool within the virtual environment operated via a first user device intersects the virtual object at a first location;
receiving, at the server, an indication of a selection of an annotation option at the first user device to generate an attachment to the virtual object;
determining a type of attachment to attach to the virtual object;
saving the attachment with an association to the first location to the memory; and
displaying, via the first user device, an indication of the attachment at the location saved to memory.

20. The method of claim 19 wherein determining that the virtual tool intersects the virtual object at the first location comprises determining when a point in the virtual environment occupied by the part of the tool is within a threshold distance from a point in the virtual environment occupied by part of the virtual object.
